(19) United States
(12) Patent Application Publication
(10) Pub. No.: US 2010/0122279 A1
(43) Pub. Date: May 13, 2010

(54) Method for Automatically Monitoring Viewing Activities of Television Signals

(76) Inventor: Ji Zhang, Monte Sereno, CA (US)

Correspondence Address: MCDERMOTT WILL & EMERY LLP, 600 13TH STREET, N.W., WASHINGTON, DC, 20005-3096, US

(21) Appl. No.: 12/085,928

(22) PCT Filed: May 26, 2008
(86) PCT No.: PCT/CN2008/071083

§ 371 Date: May 30, 2008

(51) Int. Cl. H04H 60/29

(52) U.S. Cl. 725/19

(57) ABSTRACT

A method for automatically monitoring the viewing activities of television signals, characterized by providing a measurement device, in which the television signals are adapted to be communicated to the measurement device and the TV set, making the measurement device receive the same signals as the TV set; the measurement device is adapted to extract a fingerprint data from the television signals displayed to the viewers, making the measurement device measures the same video signals as those being seen by the viewers; and the fingerprint data is transferred to a data center; and sending the television signals which the viewers are selected to watch through the measurement device to a fingerprint matcher to be monitored. The method according to the present invention does not require any change to the other devices already in place before the measurement device is introduced into the connections.

### FIELD OF THE PRESENT INVENTION

The present invention relates to a method for automatically monitoring the viewing activities of television signals.

The so called term “fingerprint” appearing in this specification means a series of image sample information, in which each sample information is selected from a digitized frame of television signals, and a plurality of frames can be selected from the television signals, and one or more sample values can be selected from one video frame of television signals, so that the so called “fingerprint” can be used to uniquely identify the said television signals.

### BACKGROUND OF THE PRESENT INVENTION

In broadcast television, one of the key questions advertisers often ask television programmers is how many people are watching their specific program channel. This determines the impact of a specific type of commercial on the viewer population. This is called the channel rating measure. It largely affects the price advertisers are willing to pay for a specific TV commercial slot available (called commercial avails, or simply avails) on that channel. For the programmers, they want to have as many people watching their specific channel as possible so that they can charge as much as possible for carrying the ad. For the advertisers and TV programmers, they want to know the rating number as accurately as possible so that they can use the information to get the best price from their own perspectives.

With the growing deployment of interactive television, advertisers and programmers alike also see the need to have the viewing patterns of specific viewers. This is often called addressable targeting. With addressable targeting, it is possible for the advertisers to deliver advertising messages specific for the viewer or viewer family. This can significantly increase the relevance of their advertising message and increase the chance that the viewers can be converted into paying customers.

Therefore, there is a need to measure the viewing activity on specific channels by specific viewers. In other words, there is a need to measure how many people are watching a specific television channel, and what specific channels a particular viewer is watching at the time.

Because it is generally impossible to measure the viewing patterns for all of the people watching television, the viewing population must be sampled to a smaller number of people to make the measurement more tractable. The population is sampled in such a way that their demographics, i.e., age, incoming level, ethnic background, and profession, etc., correlates closely to the general population. When this is the case, the sampled population can be considered as a proxy to the entire population as far as measured results are concerned. Several techniques have been developed to provide this information.

In one method, each of the sampled viewer or viewer family is given a paper diary. The sampled viewer needs to write down their viewing activities each time they turn on the television. The diary is then collected periodically to be analyzed by the data center.

In another method, each sampled viewing family is given a small device and a special purpose remote control. The remote control records all of the viewers' channel change and on/off activities. The data is then periodically collected and sent back to data center for further analysis. At the data center, the viewing activity is correlated to the program schedule present at the time of the viewing, the information on which channels are watched at any specific time can be obtained.

In another method, programmers modify the broadcast signal by embedding some specially coded signals into invisible portion of the broadcast signal. This signal can then be decoded by a special purpose device at the viewer home to determine which channel the viewer is watching. The decoded information is then sent to the data center for further analysis.

In yet another method, an audio detection device is used to decode hidden audio codes within the in-audible portion of the television broadcast signal. The decoded information can then be collected and sent to the data center for further analysis.

The first method above, the measurement can have serious accuracy problems, because it requires the viewers to write down, often in 15 minute intervals, what they are watching. Many times, viewers may forget to write it down on their diaries at the time of watching TV, and frequent channel changes can further complicate this problem.

The second method above can only be applied to the viewing of live television programming because it requires the real-time knowledge of program guide. Otherwise, only knowing the channel selected at any specific time will not be sufficient to determine what program the viewer is actually watching. For non-real-time television content, the method cannot be used. For example, a viewer can records the broadcast video content onto a disk-based PVR, and then plays it back at a different time, with possible fast forward, pause and rewind operations. In these cases, the original program schedule information can no longer be used to correlate to the content being viewed, or at least it would require change of the PVR hardware. In addition, the method cannot be used to track viewing activities of other media, such as DVD and personal media players because there are no pre-set schedules for the content being played. Therefore, the fundamental limitation of this method lies in the fact that the content being viewed must have associated play-out schedule information available for the purpose of measuring the viewing histories. This requirement cannot be met in general for content played from stored media because the play-out activity cannot be predicted ahead of time.

The third and fourth methods above both require modification to the television signals at the origination point before the signal is broadcast to the viewers. This may not always be possible given the complexity and regulatory requirement on such modifications.

### SUMMARY OF THE INVENTION

It is object of the present invention to provide a method for automatically monitoring the viewing activities of television signals, which can monitor the viewing patterns of video signals in as many different devices as possible, including television signals, PVR play-outs, DVD players, portable media players, and mobile phone video players.

It is another object of the present invention to provide a method for automatically monitoring the viewing activities of television signals, which can provide accurate measure of the number of viewers.

It is another object of the present invention to provide a method for automatically monitoring the viewing activities of television signals, which can measure the viewing activities of pre-recorded video content that has not been distributed over the television broadcast network.

It is another object of the present invention to provide a method for automatically monitoring the viewing activities of television signals, which can reduce the hardware cost of the device used to perform such measurement.

Therefore, there is provided a method for automatically monitoring the viewing activities of television signals, characterized by providing a measurement device, in which the television signals are adapted to be communicated to the measurement device and the TV set, making the measurement device receive the same signals as the TV set; the measurement device is adapted to extract a fingerprint data from the television signals displayed to the viewers, making the measurement device measures the same video signals as those being seen by the viewers; and the fingerprint data is transferred to a data center; and sending the television signals which the viewers are selected to watch through the measurement device to a fingerprint matcher to be monitored.

Preferably, each measurement device is installed in a viewer residence which is selected by demographics.

Preferably, the demographics includes the household income level, the age of each household member, the geographic location of the residence, and/or the viewer past viewing habit.

Preferably, the measurement device is connected to the internet to continuously send the fingerprint data to the data center; a local storage is integrated into the measurement device to temporarily hold the fingerprint data and upload the fingerprint data to the data center on periodic basis; or the measurement device is connected to a removable storage onto which the fingerprint data is stored, and the viewers periodically unplug the removable storage and then send it back to the data center.

Preferably, the measurement devices are typically installed in different areas away from the data center.

Preferably, the television signals come from TV programs produced specifically for public distribution, recording of live TV broadcast, movies released on DVDs and video tapes, or personal video recordings with the intention of public distribution.

Preferably, the fingerprint matcher is adapted to receive the fingerprint data from a plurality of measurement devices located in a plurality of viewer residence.

Preferably, the measurement device is adapted to receive actual clips of digital video content data, perform the fingerprint extraction and pass the fingerprint data to the fingerprint matcher and a formatter.

Preferably, the measurement device, the data center, and the fingerprint matcher are situated in geographically separate locations.

Preferably, the television signals are adapted to be communicated to the measurement device and the TV set in a parallel connection way.

According to the present invention, the proposed method does not require any change to the other devices already in place before the measurement device is introduced into the connections.

### BRIEF DESCRIPTION OF ACCOMPANYING DRAWINGS

FIG. 1 is a schematic view for measuring the television viewing patterns through the deployment of many measurement devices in viewer homes.

FIG. 2 is an alternative schematic view for measuring the television viewing patterns through the deployment of many measurement devices in viewer homes.

FIG. 3 is a schematic view for a preferred embodiment of data center used to process information obtained from video measurement devices for measurement of video viewing history.

FIG. 4 is a schematic view to show that different types of recorded video content can be registered for the purpose of further identification at a later time.

FIG. 5 is a schematic view to show how different types of recorded video content can be converted by different means for the purpose of fingerprint registration.

FIG. 6 is a schematic view to show fingerprint registration process.

FIG. 7 is a schematic view to show content registration occurring before content delivery.

FIG. 8 is a schematic view to show content delivery occurring before content registration.

FIG. 9 is a schematic view to show the key modules of the content matcher.

FIG. 10 is a schematic view to show the key processing components of the fingerprint matcher.

FIG. 11 is a schematic view to show the operation by the correlator used to determine if two fingerprint data are matched.

FIG. 12 is a schematic view to show the measurement of video signals at viewers homes.

FIG. 13 is a schematic view to show the measurement of analog video signals.

FIG. 14 is a schematic view to show the measurement of digitally compressed video signals.

FIG. 15 is a schematic view to show fingerprint extraction from video frames

FIG. 16 is a schematic view to show the internal components of a fingerprint extractor

FIG. 17 is a schematic view to show the preferred embodiment of sampling the video frames in order to obtain video fingerprint data.

### DETAILED DESCRIPTION OF THE PRESENT INVENTION

In the invention, there is provided a method for accurately determining the video content through a measurement device so that the measurement can be used to establish the viewing patterns for specific viewers connected to the device.

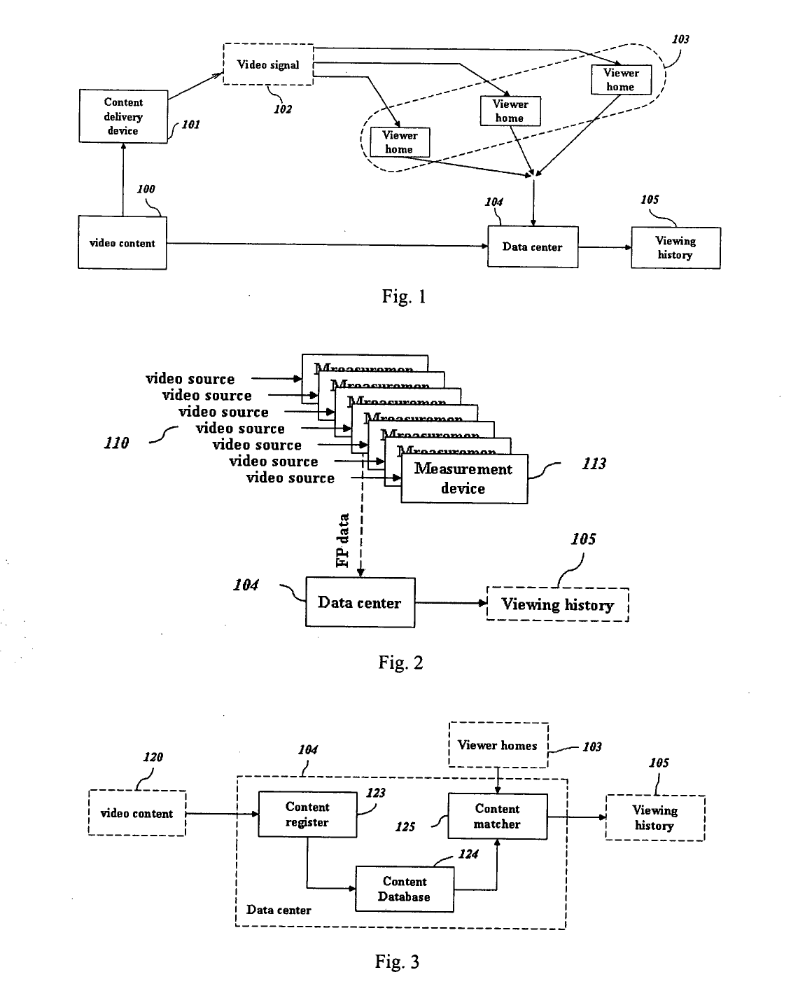

The method consists of several key components. The first component is a hardware device that must be situated in the viewers' homes. The device is connected to the television set in one end and to the incoming television signal in the other end. This is shown in FIG. 1. The video content 100 is to be delivered to the viewer homes 103 through broadcasting, cable or other network means. The content delivery device 101 therefore can be over-the-air transmitter, cable distribution plant, or other network devices. The video signals 102 arrive at the viewer homes 103. There may be many channels (also called programs) to choose from by the viewers at home. The viewer homes 103 and the source of the video content 100 are both connected to a data center 104 in some way. This can be either an IP network or a removable storage device. The data center processes the information obtained from the video content and from the viewer homes to obtain viewing history information.

The data center 104 may be co-located with the video content source 100. The Content delivery device may be a network (over-the-air broadcast, cable networks, satellite broadcasting, IP networks, wireless network), or a storage media (DVD, portable disk drives, tapes, etc.).

Next look at FIG. 2, at each of the viewer homes, a measurement device 113 is connected to receive the video content source 110 and send measurement data (hereby called fingerprint data) to the data center 104, which is used together with the prior information obtained from the video content source to obtain viewing history 105.

In FIG. 3, the data center 104 is further elaborated, where there are two key components. The content register 123 is a device used to obtain key information from the video content 120 distributed to viewer homes 103. The registered content is represented as database entries and is stored in the content database 124. The content matcher 125 receives fingerprint data directly from viewer homes 103 and compares that with the registered content information within the content database 124. The result of the comparison is then formatted into a viewing history 105.

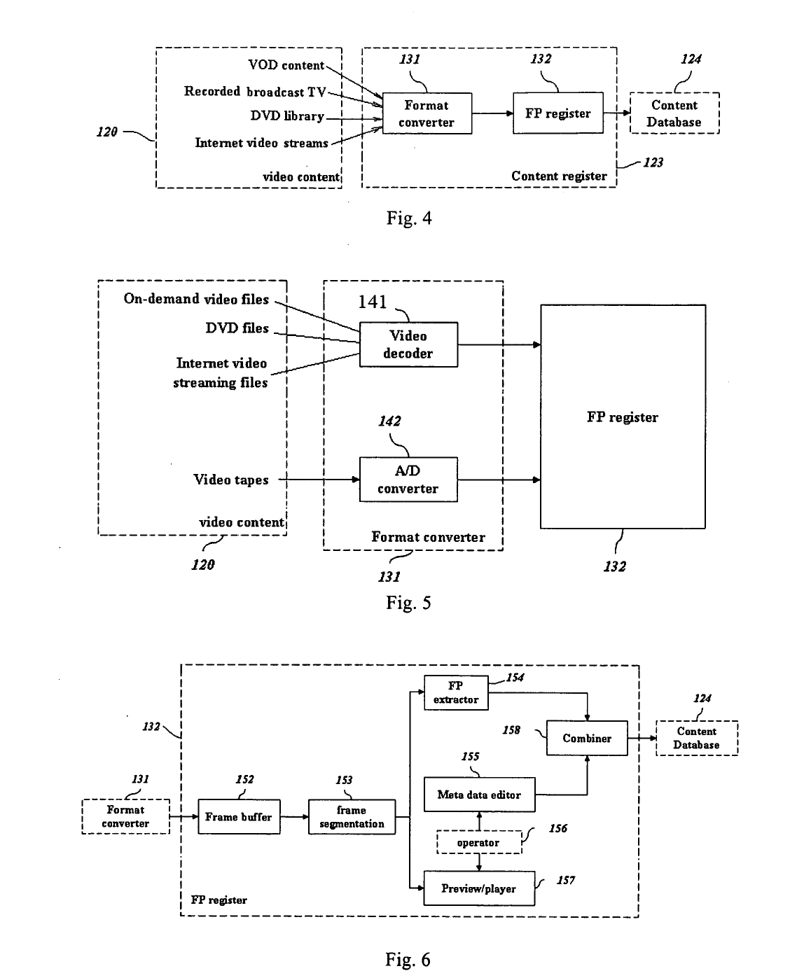

FIG. 4 further elaborates the internal details of the content register 123, which contains two key components. The format converter 131 is used to convert various analog and digital video content formats into a form suitable for further processing by the fingerprint register 132. More specifically, look at FIG. 5, where the format converter 131 is further elaborated to include two modules. The first module, the video decoder 141, is used to take compressed video content data as input, perform decompression, and output the uncompressed video content as consecutive video images to the fingerprint register 132. Separately, an A/D converter 142 handles the digitization of analog video signals, such as video tape or analog video signals. The output of the A/D converter 142 is also sent to the fingerprint register 132. In other words, at the input of the fingerprint register, all video content is converted into time consecutive sequence of uncompressed digital video images, and these images are represented as binary data, preferably in a raster scanned format, and be transferred to 132.

FIG. 6 further elaborates the internals of fingerprint register 132. At its input is the frame buffer 152, which is used to temporarily hold the digitized video frame images. The frames contained in the frame buffer 152 must be segmented into a finite number of frames in frame segmentation 153. The segmentation is necessary in case the video content is a time-continuous signal without any ending. The segmented frames are then sent to both a fingerprint extractor 154 and a preview/player 157. The fingerprint extractor 154 obtains essential information from the video frames in as small data size as possible. The preview/player 157 presents the video images as time-continuous video content for operator 156 to view. in this way, the operator can visually inspect the content segment and provide further information on the content. This information is converted into meta data through a meta data editor 155. The information may preferably include, but not limited to, type of content, key word descriptions, content duration, content rating, or anything that the operator considers as essential information in the viewing history data. The output of the fingerprint extractor 154 and the meta data editor 155 are then combined into a single identity through the use of a combiner 158, which will then put it into a content database 124. The data entry in the content database therefore not only contains essential information about a content segment, but also contains the fingerprint of the content itself. This fingerprint will later be used to automatically identify the content if and when it used to appear in the viewer homes.

Once a video content has been registered, its fingerprint is also available for matching operations with the collected remote content fingerprint data. Therefore, the fingerprint registration, as outlined in FIG. 6, will be used to register as much video content as possible. Ideally, all video content that is to be distributed to the viewers in whatever ways shall be registered so that they can be recognized automatically at a later time when they appear on viewer television screens.

Specially, the content register, the content database and the content matcher may be situated in geographically separate locations; the content register may register only a portion of the content, not all of them; the registered content may include at least recording of live TV broadcast, movies released on recorded media such as DVDs and video tapes, TV programs produced specifically for public distribution, personal video recordings with the intention of public distribution (such as youtube clips, and mobile video clips); the viewing history contains time, location, channel and content description for the matched content fingerprint; the frame segmentation is used to divide the frames into groups of fixed number of frames, say, each group with 500 frames; the frame segmentation may discard some frames periodically so that not all of the frames are registered, for example, sample 500 frames, then discard 1000 frames and then sample another 500 frames, and so forth; the FP extractor may perform sampling differently depending on the group of frames, for some groups of frames, it may take 5 samples per frame, and for some other groups of frames, it may take 1 sample per frame, yet for some other groups of frames, it may take 25 samples per frame; and the preview/player 157 may take its input directly from a compressed video content segment, bypassing 131, 152 and 153 entirely, in this case, the preview/player performs the decompression, frame buffering, frame segmentation and display.

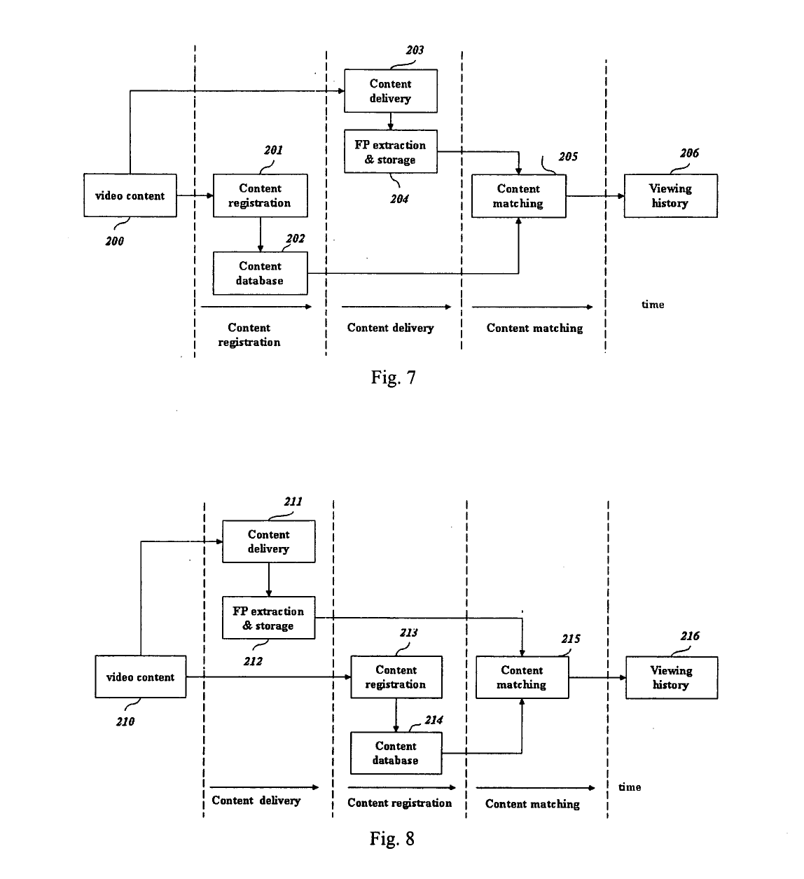

To better understand the processing flow at the data center, there is provided two cases. In the first case, shown in FIG. 7, the video content 200 is first registered by a content registration 201 and the registered result is stored in the content database 202. This occurs before the actual delivery of the video content to viewer homes.

At a later time, the content is delivered by a content delivery device 203. At the viewer homes, fingerprint extraction is performed 204 on the delivered video content. In addition, in a preferred embodiment, the extracted fingerprint data is immediately transferred to the data center, put into a storage device, and separated from the already-registered content. In another embodiment, the extracted fingerprint data is saved in the devices installed at the viewer homes and will be transferred to the data center at a later time when requested. The data center then compares the stored fingerprint archive data with the fingerprint within the content database 202. This is accomplished by content matching 205.

In another embodiment, as shown in FIG. 8, the video content is delivered by a content delivery 211 at the same time registered at the content registration 213. The fingerprint extraction 212 occurs at the same time as the content delivery 211. The extracted fingerprint data is then transferred to the data center for content matching. Alternatively, the fingerprint data is stored locally at the viewer home devices for later transfer to the data center.

At the data center, after both the extracted fingerprint data from the delivered content and the registered content information are both available, the content matching 215 can be performed to come up with the viewing history 216.

Comparing FIG. 7 and FIG. 8, it is noted that the key difference between the two approaches lies in the relative time sequence of content delivery and content registration. Typical scenarios for FIG. 7 includes video content that has been pre-recorded, such as movies, pre-recorded television programs and TV shows, etc. In other words, in these cases, the pre-recorded content can be made accessible by the operators of the data center before they are delivered to the viewer homes. For FIG. 8, the typical scenario is for live broadcast of TV content, this may include evening real-time news broadcast or other content that cannot be accessed by data center until the content is already delivered to the viewer homes. In this case, the data center first obtains a recording of the content and registers it at a later time. By now, the fingerprint data has been extracted at the viewer homes and possibly already transferred to the data center. In other words, the fingerprint may already be available before the content has been registered. After the registration, the content matching can then take place.

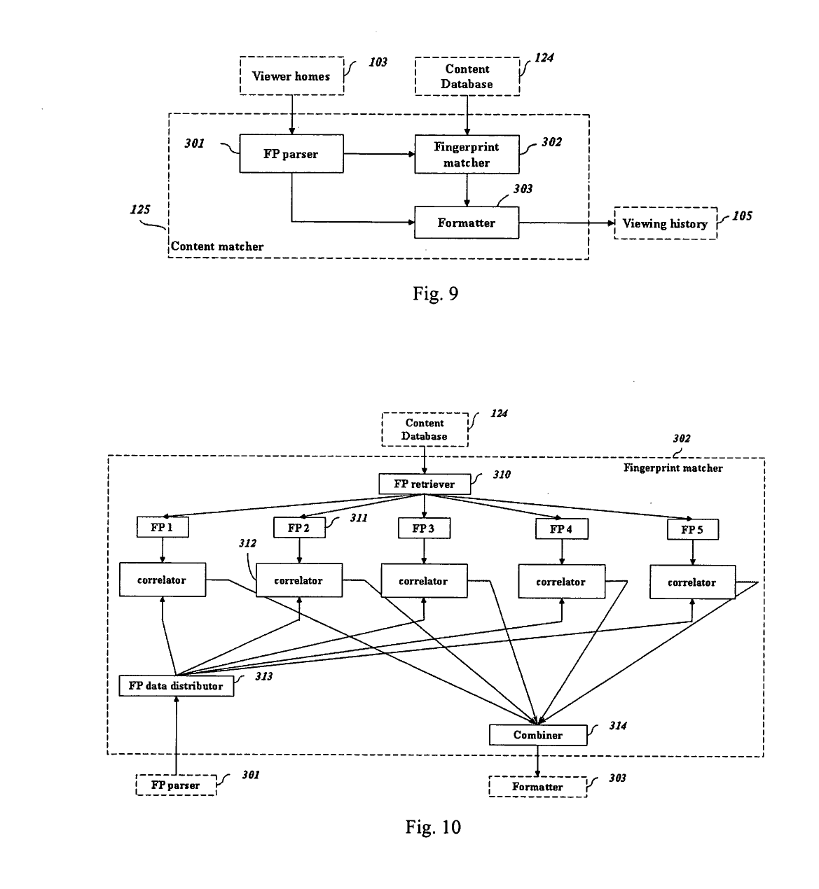

Next, look at the content matching process, as shown in FIG. 9. The content matcher 125 contains three components, a fingerprint parser 301, a fingerprint matcher 302, and a formatter 303. The fingerprint parser 301 receives the fingerprint data from the viewer homes. The parser 301 may receive the data over an open IP network, or it may receive it through the use of removable storage device. The parser 301 then parses the fingerprint data stream out of other data headers added for the purpose of reliable data transfers. In addition, the parser also obtains information specific to the viewer home where the fingerprint data comes from. Such information may include time at which the content was measured, location of the viewer home, and the channel on which the content was viewed, etc. This information will be used by the formatter 303 in order to generate viewing history 105.

The fingerprint matcher 302 than takes the output of the parser 301, retrieves the registered video content fingerprints from the content database 124, and performs the fingerprint matching operation. When a match is found, the information is formatted by the formatter 303. The formatter takes the meta data information associated with the registered fingerprint data that is matched to the output of the parser 301, and creates a message that associates the meta data with the viewer home information before it is sent as viewing history 105.

Specially, the content matcher receives incoming fingerprint streams from many viewer homes 103, and parses them out to different fingerprint matchers; and the content matcher receives actual clips of digital video content data, performs the fingerprint extraction, and passes the fingerprint data to fingerprint matcher and formatter.

Next, it is to describe how the fingerprint matcher operates, as shown in FIG. 10. The input to the fingerprint matcher is from the fingerprint parser 301. For the sake of illustration, it assumed that only the fingerprint data from a single measured video channel is sent by the fingerprint parser. But it's straightforward to see multiple video channels can be handled similarly. The fingerprint data is replicated by a fingerprint distributor 313 to multiple correlation detectors 312. Each of these detectors takes two fingerprint data streams. The first is the continuous fingerprint data stream from the fingerprint distributor 313. The second is the registered fingerprint data segment retrieved by fingerprint retriever 310 from the content database 124. Multiple fingerprint data segments are retrieved from the database 124. Each segment may represent a different time section of the registered video content. In FIG. 10, five fingerprint segments 311, labeled as FP1, FP2, FP3, FP4, and FP5, are retrieved from the content database 124. These five segments may be registered fingerprints associated with time-consecutive content, in other words, FP2 is for video content immediately after the video content for FP1, so on and so forth.

Alternatively, they may be for non-consecutive time-sections for the original video content. For example, FP1 maybe for time [1, 3] seconds (it means 1 sec through 3 sec, inclusive), and FP2 for time [6,8] seconds, and FP3 for time [11,100] seconds, and so forth. In other words, the length of video content represented by the fingerprint segments may or may not be identical. They may not be spaced uniformly either.

Multiple correlators 312 operate concurrently with each other. Each compares a different fingerprint segment with the incoming fingerprint data stream. The correlators generate a message indicating a match when a match is detected. The message is then sent to the formatter 303. The combiner 314 receives messages from different correlators and passes them to the formatter 303.

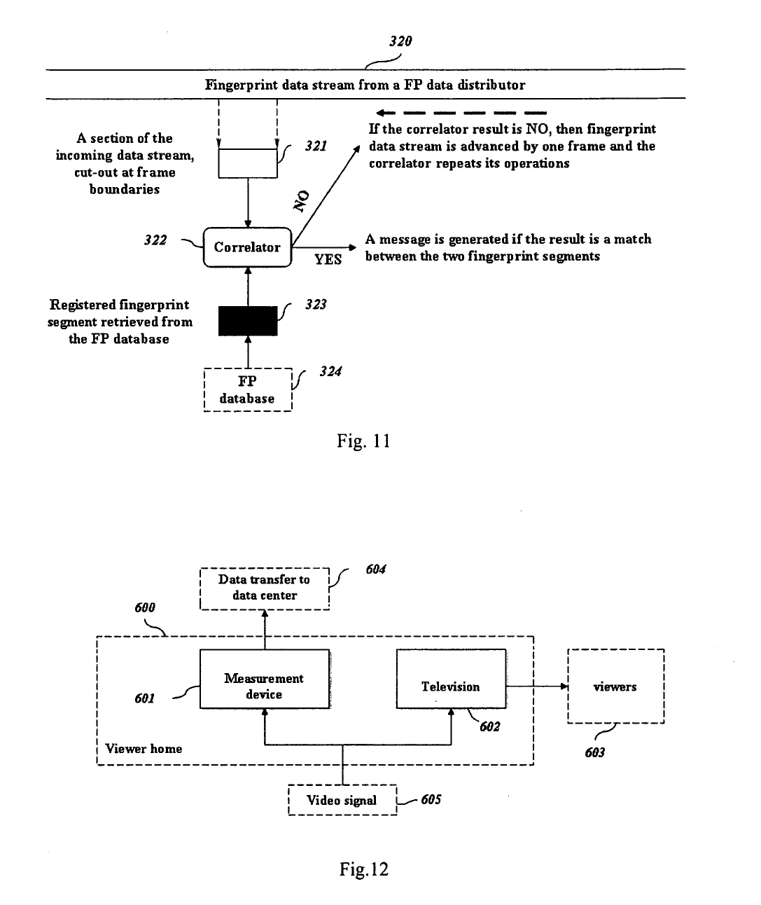

FIG. 11 illustrates the operation of the correlator. Specifically, the fingerprint data stream 320 was received from the FP data distributor. A section of the data is copied out from a fingerprint section 321. The boundary of the section falls on the boundaries of the frames from which the fingerprint data was extracted. Separately, a registered fingerprint data segment 323 was retrieved from the FP database 324. The correlator 322 then performs the comparison between the fingerprint section 321 and the registered fingerprint data segment 323. If the correlator determines that a match has been found, it writes out a ‘YES’ message and then retrieves an entire adjacent section of the fingerprint data from the fingerprint data stream 320. If the correlator determines that a match has NOT been found, it writes out a ‘NO’ message. The fingerprint section 321 advances the fingerprint data by one frame's worth of data samples and the entire correlator process is repeated.

Next consider what happens at the viewer homes, as shown in FIG. 12.

The television signal 605 is assumed to be in analog formats, and is connected to the measurement device 601. The measurement device 601 receives the same signal as the connected television set 602. The measurement device 601 extracts fingerprint data from the video signal. The television signal is displayed to the viewers 603, which means that the measurement device 601 measures the same video signal as it is seen by the viewers 603. The measurement is represented as fingerprint data streams which will be transferred to the data center 604. The viewer may have a remote control or some other devices that select the right television channel that they want to watch. Whatever channel selected will be sent through the television signal of the connected television set 602 and then measured by the measurement device 601. Therefore, the proposed method does not require any change to the other devices already in place before the measurement device 601 is introduced into the connections.

In an alternative embodiment, the measurement device 601 passes through the signal to the television 602. The resulting scheme is identical to that of FIG. 12 and discussions will not be repeated here.

The measurement device 601 extracts the video fingerprint data. The video fingerprint data is a sub-sample of the video images so that it provides a representation of the video data information sufficient to uniquely represent the video content. Details on how to use this information to identify the video content are described by a provisional U.S. patent application No. 60/966,201 filed by the present inventor.

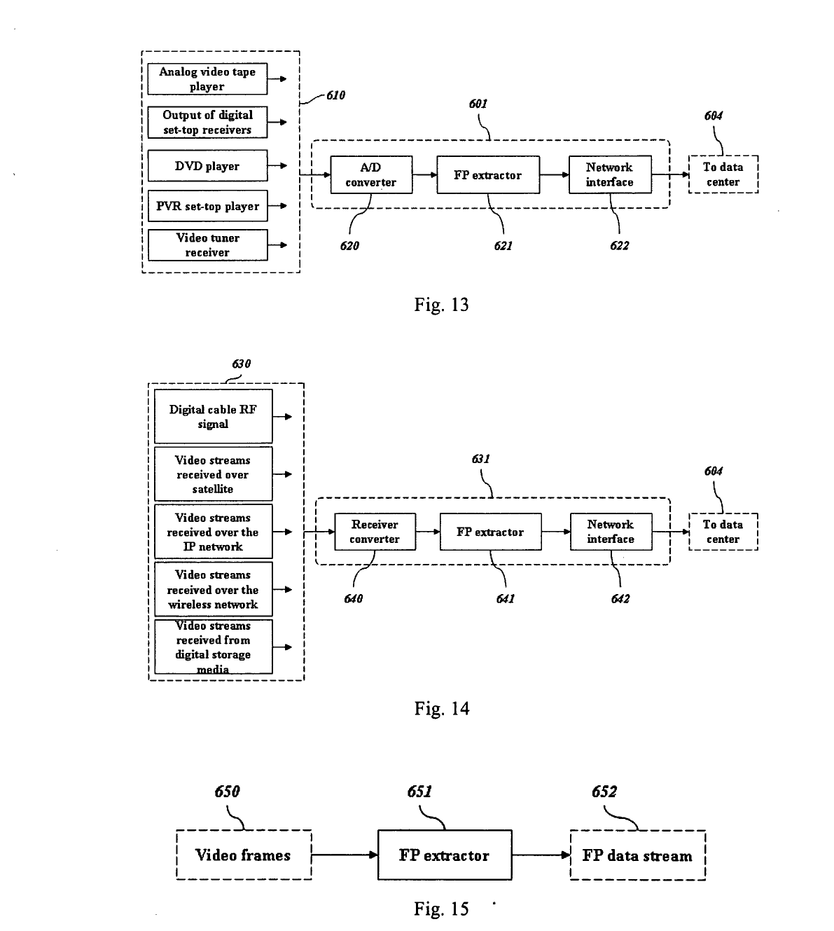

A preferred embodiment of the measurement device 601 is shown in FIG. 13, in which the incoming video signal is in an analog format 610, either as composite video signal or as component video signal. The source for such signals can be an analog video tape player, an analog output of a digital set-top receiver, a DVD player, a personal video recorder (PVR) set-top player, or a video tuner receiver. Once entering the device, the signal is decoded by an A/D converter 620, digitized into video images, and transferred to fingerprint extractor 621. The fingerprint extractor 621 samples the video frame data as fingerprint data, and sends the data over the network interface 622 to the data center 604.

Another embodiment of the measurement device 631 is shown in FIG. 14. In this embodiment, the video signal 630 is in digital format in various forms. In this case, the video signal is already encoded as data streams using digital compression techniques. Common digital compression formats include MPEG-2, MPEG-4, MPEG-4 part 10 (also called H.264), windows media, and VC-1. The digital video data stream can be modulated to be carried over radio frequency spectrum on a digital cable network, or the digital video streams are carried over a spectrum on the satellite transponder spectrum for wider area distributions, or the video stream can be carried as data packets distributed over internet protocol (IP) networks, or the video streams can be carried over a wireless data network, or the video streams can be stored as data files on a removable storage media (such as DVD disks, disk drives, or solid states flash drives) and be transferred by hands. The receiver converter 640 takes the input video data streams received from one of the above interfaces, and performs the demodulation and decompression as necessary to extract the uncompressed video frame data. The frame data is then sent to the fingerprint extractor 641 for further processing. The rest of the steps are identical to those of FIG. 13 and will not be repeated here.

It is important to point out that in any of the above embodiments, the video input signal that the viewers see is not altered in anyway by the measurement device.

In the above discussion, it is assumed that audio signal is passed through along with the video signal and no further processing is performed.

In addition, the measurement device needs to locally store the fingerprint data and send it back to the data center for further processing. There are at least three ways to send the data. One preferred embodiment thereof is to have the device connected to the internet and continuously send back the collected data to the data center. In another embodiment thereof, a local storage is integrated into the device to temporarily hold the collected data and upload the data to the center on periodic basis. In another embodiment thereof is to have the device connected to a removable storage, such as a USB flash stick, and the collected video fingerprint data is stored onto the removable storage. Periodically, the viewers can unplug the removable storage, replace it with a blank, and then send back the replaced storage to the data center by mail.

Next, it is to describe the operations of the fingerprint extractor. See FIG. 15, which shows that the video frames 650, which are obtained by digitizing video signals, are transferred to the fingerprint extractor 651 as binary data. The output of 651 is the extracted fingerprint data 652, which usually has much smaller data size than the original video frame data 650.

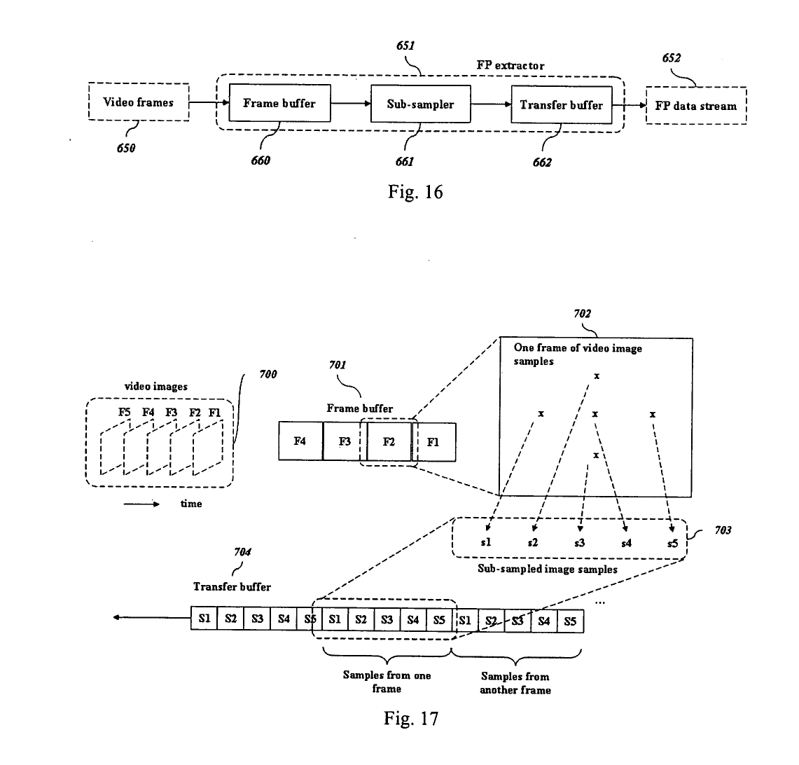

FIG. 16 further illustrates the internal components for the fingerprint extractor 651. Specifically, the video frames 650 are first transferred into a frame buffer 660, which is a data buffer used to temporarily hold the digitized frames and organized in image scanning orders. The sub-sampler 661 then takes image samples from the frame buffer 660, organizes the samples, and sends the result to transfer buffer 662. The transfer buffer 662 then delivers the data as fingerprint data streams 652.

It is now to focus on the internal operations of the fingerprint extractor in some greater detail, see FIG. 17.

In FIG. 17, the video images are presented as digitized image samples and organized on a per frame basis 700. In an preferred embodiment, five samples are taken from each video frame. The frames F1 , F2, F3, F4 and F5 are time continuous sequence of video images. The intervals between the frames are 1/25 second or 1/30 second, depending on the frame rate as specified by the different video standard (such as NTSC or PAL). The frame buffer 701 holds the frame data as organized by the frame boundaries. The sampling operation 702 is performed on one frame at a time. In the example shown in FIG. 17, five image samples are taken out of a single frame, and are represented as s1 through s5, as referred to with the reference number 703. These five samples are taken from different locations of the video image. One preferred embodiment for the five samples is to take one sample at the center of the image, one sample at the half way height and half way left of center of image, another sample at the half way height and half way right of center of image, another sample at half width and half way on top of center of image, and another sample at half width and half way below of center of image.

In the preferred embodiment, each video frames are sampled exactly the same way. In other words, the image samples from the same positions are sampled for different images, and the same number of samples is taken from different images. In addition, the images are sampled consecutively.

The samples are then organized as part of the continuous streams of image samples and placed into the transfer buffer 704. The image samples from different frames are organized together into the transfer buffer 704 before it is sent out.

Specially, the above sampling method can be extended beyond the preferred embodiment to include the following variations: the sampling position of each image may change from image to image; different number of samples may be taken for different video images; and sampling on images may be performed non-consecutively, in other words, the number of samples taken from each image may be different.

The above discussions can be applied to other fields by those familiar with the general technical field of expertise. These include, but not limited to, situations where the video content may be compressed in MPEG-2, MPEG-4, H.264, WMV, AVS, Real, and other future compression formats. The method can also be used in monitoring audio and sound signals. The method can also be used in monitoring video content that is re-captured in consumer or professional video camera devices. The method can also be extended in areas where there is a centralized registry of content meta data and a network connected system of remote collection devices.

1. A method for automatically monitoring the viewing activities of television signals, characterized by
providing a measurement device, in which the television signals are adapted to be communicated to the measurement device and the TV set, making the measurement device receive the same signals as the TV set; the measurement device is adapted to extract a fingerprint data from the television signals displayed to the viewers, making the measurement device measures the same video signals as those being seen by the viewers; and the fingerprint data is transferred to a data center; and
sending the television signals which the viewers are selected to watch through the measurement device to a fingerprint matcher to be monitored.

2. The method of claim 1, wherein each measurement device is installed in a viewer residence which is selected by demographics.

3. The method of claim 2, wherein the demographics includes the household income level, the age of each household member, the geographic location of the residence, and/or the viewer past viewing habit.

4. The method of claim 1, wherein
the measurement device is connected to the internet to continuously send the fingerprint data to the data center;
a local storage is integrated into the measurement device to temporarily hold the fingerprint data and upload the fingerprint data to the data center on periodic basis; or
the measurement device is connected to a removable storage onto which the fingerprint data is stored, and the viewers periodically unplug the removable storage and then send it back to the data center.

5. The method of claim 1, wherein the measurement devices are installed in different areas away from the data center.

6. The method of claim 1, wherein the television signals come from TV programs produced specifically for public distribution, recording of live TV broadcast, movies released on DVDs and video tapes, or personal video recordings with the intention of public distribution.

7. The method of claim 2, wherein the fingerprint matcher is adapted to receive the fingerprint data from a plurality of measurement devices located in a plurality of viewer residence.

8. The method of claim 1, wherein the measurement device is adapted to receive actual clips of digital video content data, perform the fingerprint extraction and pass the fingerprint data to the fingerprint matcher and a formatter.

9. The method of claim 1, wherein the measurement device, the data center, and the fingerprint matcher are situated in geographically separate locations.

10. The method of claim 1, wherein the television signals are adapted to be communicated to the measurement device and the TV set in a parallel connection way.
